(19) United States
(12) Patent Application Publication
(10) Pub. No.: US 2019/0107730 A1
(43) Pub. Date: Apr. 11, 2019

(54) IMAGING SYSTEM AND IMAGING METHOD

(71) Applicant: Lenovo (Beijing) Co., Ltd., Beijing (CN)

(72) Inventors: Changsheng LIU, Beijing (CN); Fan ZHANG, Beijing (CN)

(21) Appl. No.: 16/156,060

(22) Filed: Oct. 10, 2018

(30) Foreign Application Priority Data
Oct. 10, 2017 (CN) 201710935308.9

(51) Int. Cl. G02B 27/28; H04N 5/235; H04N 5/265; H04N 5/243

(52) U.S. Cl. CPC G02B 27/288; H04N 5/2351; H04N 5/2254; H04N 5/243; H04N 5/265

(57) ABSTRACT

An imaging system including an image processor and a lens module coupled to the image processor. The lens module includes a polarizer, a lens, and a photosensitive sensor. The polarizer has a polarization angle and filters light according to the polarization angle. The lens is arranged adjacent to the polarizer to receive the light filtered through the polarizer. The photosensitive sensor is arranged adjacent to the lens. The photosensitive sensor can sense light to generate image information. The image processor can obtain information of polarized light according to the image information of an image and to generate a target image.

### CROSS-REFERENCE TO RELATED APPLICATION

This application claims the priority of China Application No. 201710935308.9, filed on Oct. 10, 2017, the entire content of which is incorporated herein by reference.

### TECHNICAL FIELD

The present disclosure relates to the field of electronic device technologies and, in particular, to an imaging system and an imaging method.

### BACKGROUND

With the continuous development of science and technology, more and more electronic devices with imaging functions are widely used. The electronic devices with imaging functions bring great convenience to the users and have gained user popularity. Further, images obtained by the electronic devices can be processed by applying artificial intelligence, machine learning, and deep learning technologies to meet functional requirements of the users.

In an imaging process of an electronic device, specular reflection in the photographing environment caused by reflective surfaces, such as a glass window or a mirror, may result in an image blurring in a region corresponding to the specular reflection, affecting the imaging quality of the electronic device.

### SUMMARY

In accordance with the disclosure, one aspect of the present disclosure provides an imaging system a lens device with an image processor and a lens module coupled to the image processor. The lens module includes a polarizer, a lens, and a photosensitive sensor. The polarizer has a polarization angle and filters light according to the polarization angle. The lens is arranged adjacent to the polarizer to receive the light filtered through the polarizer. The photosensitive sensor is arranged adjacent to the lens. The photosensitive sensor can sense light to generate image information. The image processor can obtain information of polarized light according to the image information of an image and to generate a target image.

In some embodiments, the imaging system described above can implement an imaging method as following. The imaging method includes filtering light by the polarizer with the polarization angle, sensing the light filtered through the polarizer, acquiring the image information of the image obtained by the imaging system, calculating the information of the polarized light according to the image information of the image, and generating the target image according to the image information and the information of the polarized light.

In accordance with the disclosure, another aspect of the present disclosure provides another imaging system including an image processor, and a lens device couple to the processor. The lens device includes a plurality of lens modules. Each of the plurality of lens modules includes a polarizer, a lens, and a photosensitive sensor. The polarizer has a polarization angle and filters light according to the polarization angle. The lens is arranged adjacent to the polarizer to receive the filtered light from the polarizer. The photosensitive sensor is arranged adjacent to the lens. The photosensitive sensor can sense light to generate image information of a sub-image. Polarization angles of the polarizers in different lens modules are different form each other. The image processor can obtain information of polarized light according to the image information of each sub-image and to generate a target image with reduced polarized light.

In some embodiments, the imaging system described above can implement an imaging method as following. The imaging method includes filtering light by each polarizer with the polarization angle, sensing the light filtered through the polarizer, acquiring image information of each sub-image generated by the lens device in the imaging system, calculating the information of the polarized light according to the image information of each sub-image, and generating the target image with the polarized light reduced, according to the image information and the information of the polarized light.

### DESCRIPTION OF THE DRAWINGS

To clearly illustrate embodiments of the present disclosure or the technical solutions in conventional technologies, below briefly describes drawings describing embodiments of the present disclosure or the conventional technologies. Obviously, the drawings described below merely show some embodiments of the present disclosure. Those skilled in the art can obtain other drawings according to the drawings provide in the present disclosure without any creative effort.

FIG. 1 is a structural diagram of an imaging system according to an embodiment of the present disclosure.

FIG. 2 is a plan view of a lens device in the imaging system shown in FIG. 1.

FIG. 3 is a diagram of a cross-section of the lens device 11 when viewed at a side of the lens device 11 in a direction from P, as shown in FIG. 2.

FIG. 4 schematically shows an operation principle of a polarizer according to an embodiment of the present disclosure.

FIG. 5 is a structural diagram of an imaging system according to another embodiment of the present disclosure.

FIG. 6 is a diagram of an experiment comparing imaging effects according to an embodiment of the present disclosure.

FIG. 7 is a flowchart of an imaging method according to an embodiment of the present disclosure.

### DETAILED DESCRIPTION

Below clearly describes technical solutions according to embodiments of the present disclosure with reference to the accompany drawings. Obviously, the embodiments described below are merely a part of, not all of embodiments of the present disclosure. Any other embodiment obtained by those skilled in the art based on the embodiments of the present disclosure without creative efforts shall fall within the scope of the present disclosure.

Natural light is unpolarized light, while specular-reflection light is polarized light. Considering the polarization characteristic of the specular-reflection light, a corresponding image processing method can be used to eliminate the specular-reflection light (polarized light vibrating of a single angle). Such designs may avoid blurring image caused by the specular reflection, improving imaging quality of an electronic device.

Below further describes objects, features and advantages of the present disclosure in detail with reference to the drawings and embodiments.

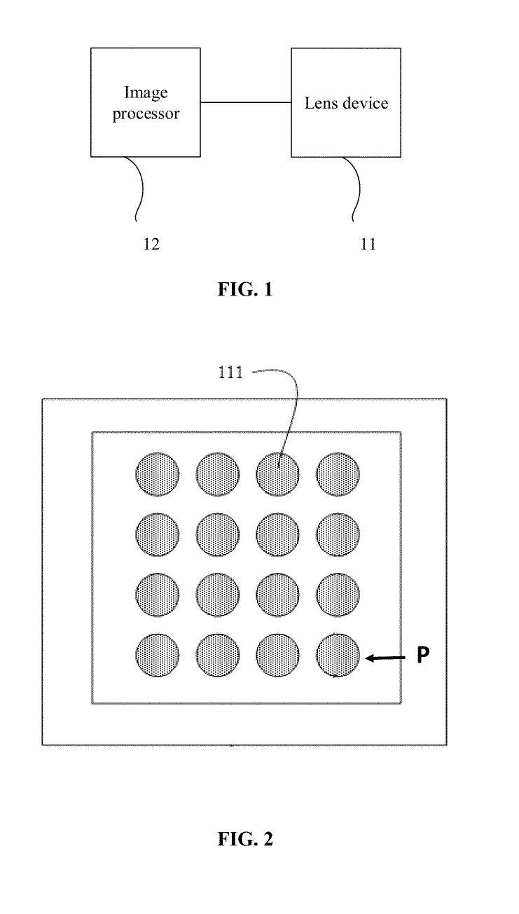

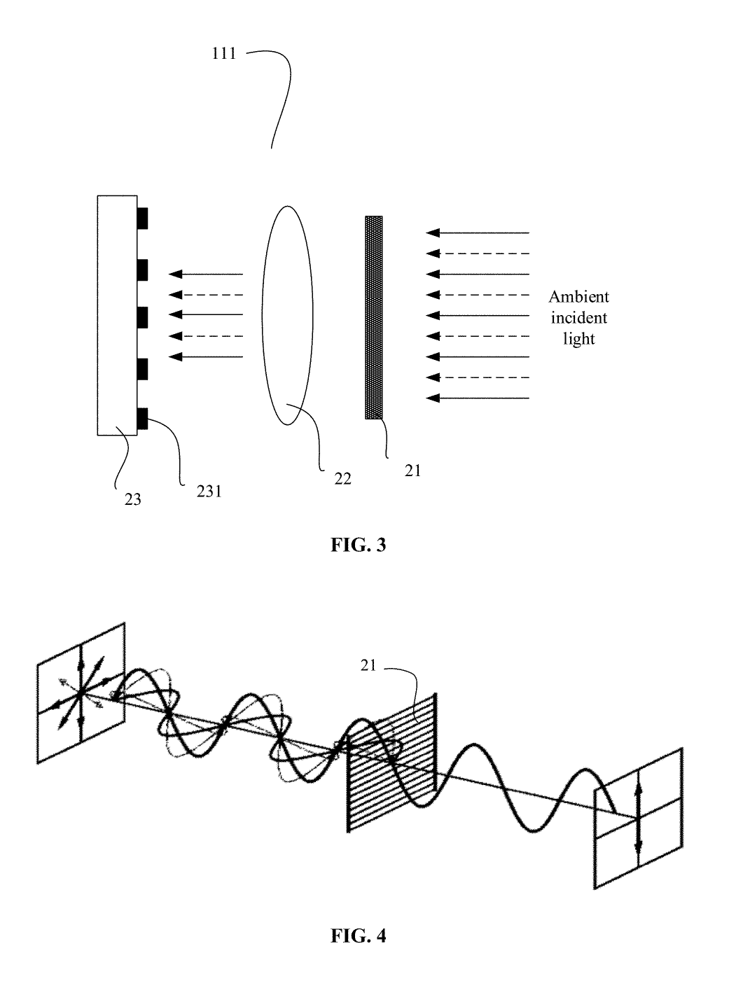

Referring to FIGS. 1-3, FIG. 1 is a structural diagram of an imaging system according to an embodiment of the present disclosure; FIG. 2 is a plan view of a lens device 11 in the imaging system shown in FIG. 1; and FIG. 3 is a diagram of a cross-section of the lens device 11 when viewed at a side of the lens device 11 in a direction from P, as shown in FIG. 2. The imaging system may include a lens device 11 and an image processor 12. Further, FIG. 2 is a plan view of the lens device 11 observed along a direction of an incident light.

The lens device 11 may include a plurality of lens modules 111. The lens module 111 may include: a polarizer 21, a lens 22 located in an area illuminated by light filtered through the polarizer 21, a photosensitive sensor 23 located in an area illuminated by light filtered through the lens 22. The photosensitive sensor 23 is configured to sense light to generate image information. Polarization angles of the polarizers 21 in different lens modules 111 are different.

The image processor 12 may be configured to obtain information of polarized light according to the image information of sub-images and generate a target image with reduced polarized light according to the image information and the information of the polarized light. The image processor 12 may be coupled to the photosensitive sensor 23 to facilitate acquisition of the image information for generating a target image with the polarized light reduced.

In some embodiments, each lens 22 of the plurality of lens modules 111 can optically process light passing through the lens 22 according to a focal length of the corresponding lens 22. Each polarizer 21 of the plurality of lens module 111 can polarize the light passing though the polarizer 21. As such, the photosensitive sensor 23 can sense the light that is optically treated by each of the plurality of lens modules 111 to generate a sub-image. The image processor 12 can be coupled to the photosensitive sensor 23 to acquire image information of the sub-images to generate the target image.

In one lens module 111, the polarizer 21, the lens 22, and the photosensitive sensor 23 may be fixed on a same base, three of which may all be located on a same optical axis. The photosensitive sensor 23 may include a plurality of photosensitive units 231 arranged in arrays for sensing light and generating the image information. In the lens device 11, the plurality of the lens modules 111 may be mounted in a same casing.

Ambient incident light includes the unpolarized natural light (shown by solid arrows in FIG. 3) and the polarized light with a single polarization angle (shown by dashed arrows in FIG. 3). FIG. 4 shows an operation principle of the polarizer 21 in the lens module 111.

FIG. 4 schematically shows an operation principle of a polarizer according to an embodiment of the present disclosure. The polarizer 21 may only allow light having a single polarization angle to pass, and light having other polarization angles may be at least partially filtered. An intensity of light that can pass through the polarizer 21 satisfies the Malus's Law, as shown below in Equation (0).

Iₒᵤₜ=Iᵢₙ×cos²θ (0)

Where, Iₒᵤₜ is an intensity of incident light input to the polarizer 21; Iᵢₙ is an intensity of light output by the polarizer 21; and θ is a difference between the polarization angle of the polarizer 21 and the polarization angle of the incident light. According to Malus's Law, θ is symmetrically distributed around 90° in the range of 0 to 180°, so the polarization angle of the polarizer 21 is evenly distributed in an interval of 0° to 90°. For a lens device 11 having 4×4 (i.e. 16) lens modules 111, the polarization angles of the 16 polarizers may be 0, 1/15×90°, 2/15×90°, . . . , 14/15×90°, and 90°.

For the lens device 11 having the plurality of lens modules 111, image information for the sub-images of a same environment can be collected at the same time. Different polarizers 21 have different polarization angles, so that degrees of filtering of different polarizers 21 are different. For the above lens device 11 having 4×4 lens modules 111, 16 image information of the same environment can be collected at one time.

In the lens device 11, for each polarizer 21 having a polarization angle, the natural light includes some polarized light that can partially pass through the polarizer 21 and has a certain fixed polarization angle. When a polarization direction of the polarized light is the same as a polarization direction of polarizer 21, all the polarized light can pass through the polarizer 21. When the polarization direction of the polarized light is perpendicular to the polarization direction of polarizer 21, all the polarized light can be filtered out by the polarizer 21. When an angle of the polarization direction of the polarized light and the polarization direction of polarizer 21 is between 0 and 90°, the polarized light can partially pass through the polarizer 21.

As described above, the ambient incident light input to the polarizer 21 includes unpolarized light and polarized light. The image processor 12 may be configured to calculate the information of the polarized light, according to a relationship between the image information and an intensity A of the unpolarized light and an intensity B of the polarized light. According to the image information corresponding to the plurality of polarizers 21 with different polarization angles, the intensity A of the unpolarized light and the intensity B of the polarized light in the ambient incident light can be calculated using the Malus's Law.

Specifically, when the polarization angles of the 16 polarizers are 0, 1/15×90°, 2/15×90°, . . . , 14/15×90°, and 90°, respectively; A is the intensity of the unpolarized light in the ambient incident light; B is the intensity of the polarized light in the ambient incident light; and a is the polarization angle of reflected light, intensity (I₁, I₂, I₃, . . . , I₁₆) of light received by the 16 photosensitive sensor 23 can be expressed as following Equations (1) to (16):

I₁=A+B×cos²(θ₁−α) (1)

I₂=A+B×cos²(θ₂−α) (2)

I₃=A+B×cos²(θ₃−α) (3)

I₄=A+B×cos²(θ₄−α) (4)

. . .

I₁₅=A+B×cos²(θ₁−α) (15)

I₁₆=A+B×cos²(θ₁₆−α) (16)

I₁ to I₁₆ are the intensities of the light corresponding to the 16 lens modules 111, and can be obtained according to corresponding image information, that is, I₁ to I₁₆ can be obtained by corresponding photosensitive sensors 23. θ₁ to θ₁₆ are polarization angles corresponding to the 16 polarizers 21 and are known parameters.

A, B, and α can be calculated by at least three equations of the Equations (1) to (16). After the intensity A of the natural light (unpolarized light) in the ambient incident light, the intensity B of the polarized light, and the polarization angle α of the polarized light, intensity and a polarization angle of unfiltered polarized light in the image information corresponding to each lens module 111 can be calculated.

A calculation method may be based on Malus's Law, selecting three equations of Malus's Law corresponding to lens modules 111 to calculate A, B, and α. For example, A, B, and α can be calculated by any three equations of Equations (1) to (16).

Another calculation method may be as following.

I₂−I₁=B×[cos²(θ₂−α)−cos²(θ₁−α)] (17)

I₃−I₁=B×[cos²(θ₃−α)−cos²(θ₁−α)] (18)

Equation (19) can be obtained by dividing equation (18) by equation (17).

$$\frac{( {I}_{3} - {I}_{1} )}{( {I}_{2} - {I}_{1} )} = \frac{{cos}^{2} ( {θ}_{3} - α ) - {cos}^{2} ( {θ}_{1} - α )}{{cos}^{2} ( {θ}_{2} - α ) - {cos}^{2} ( {θ}_{1} - α )} \qquad ( 19 )$$

Converting the above Equation (19) gives the following equation:

$$\frac{( {I}_{3} - {I}_{1} )}{( {I}_{2} - {I}_{1} )} = \frac{cos ( {θ}_{3} - α ) + cos ( {θ}_{1} - α )}{cos ( {θ}_{2} - α ) + cos ( {θ}_{1} - α )} \times \frac{cos ( {θ}_{3} - α ) - cos ( {θ}_{1} - α )}{cos ( {θ}_{2} - α ) - cos ( {θ}_{1} - α )}$$

Equation (20) can be obtain by letting

$${I}_{q} = \frac{( {I}_{3} - {I}_{1} )}{( {I}_{2} - {I}_{1} )} ,$$

and using the sum-to-product formula to simply the right side of the above equation.

$${I}_{q} = \frac{{A}_{1} \times cos ( \frac{{θ}_{3} + {θ}_{1}}{2} - α )}{{A}_{2} \times cos ( \frac{{θ}_{2} + {θ}_{1}}{2} - α )} \times \frac{{A}_{3} \times sin ( \frac{{θ}_{3} + {θ}_{1}}{2} - α )}{{A}_{4} \times sin ( \frac{{θ}_{2} + {θ}_{1}}{2} - α )} \qquad ( 20 )$$

Where, A₁, A₂, A₃, and A₄ are constants associated with the Equations (1) to (3). α can be obtained using Equation (20), so that values of A and B can be obtained by solving the matrix equations below.

$$[ \begin{matrix}1 & {cos}^{2} ( {θ}_{1} - α ) \\ 1 & {cos}^{2} ( {θ}_{2} - α ) \\ 1 & {cos}^{2} ( {θ}_{3} - α ) \\ … & … \\ 1 & {cos}^{2} ( {θ}_{16} - α )\end{matrix} ] [ \begin{matrix}A \\ B\end{matrix} ] = [ \begin{matrix}{I}_{1} \\ {I}_{2} \\ {I}_{3} \\ … \\ {I}_{16}\end{matrix} ]$$

The latter calculation method is calculated based on multiple sampled data and has higher accuracy.

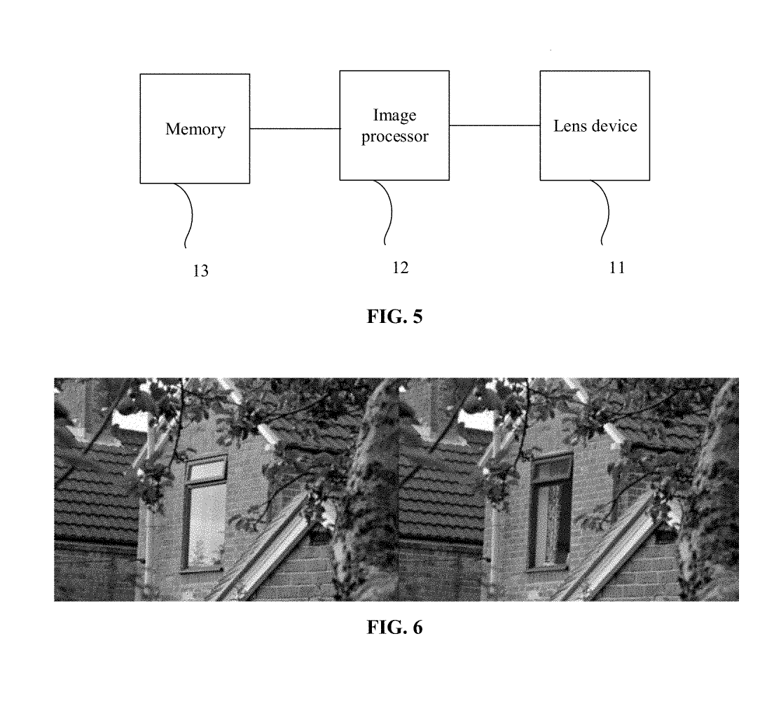

FIG. 5 is a structural diagram of an imaging system according to another embodiment of the present disclosure. On the basis of the imaging system shown in FIG. 1, the imaging system may further include a memory 13, which may be configured to store the polarization angles of the polarizer 21. The information of the polarized light may include the intensity B of the incident polarized light input to the polarizer 21 and the polarization angle α of the polarized light. The values of B and α can be obtained using the calculation methods above.

The image processor 12 can directly read the polarization angle of each polarizer 21 through the memory 13 to calculate the values of A, B, and α. The image processor 12 may be configured to calculate the intensity of the polarized light in the image information based on the intensity B of the incident polarized light to the polarizer 21, the polarization angle α of the polarized light, and a current polarization angle θᵢ of the polarizer 21. The image processor 12 may be configured to generate the target image based on the calculation result.

Methods for generating the target image with reduced polarized light by the image processor 12 may include the following two exemplary methods.

In a first exemplary method, the image processor 12 may be configured to calculate the intensity of the polarized light in the image information and generate the target image with reduced polarized light based on the image information and the intensity of the polarized light in the image information.

In this exemplary method, after obtaining A, B, and α, the image processor 12 may further configured to calculate the intensity and polarization angle of the unfiltered polarized light in the image information corresponding to each lens module 111. Further, the image processor 12 can eliminate the unfiltered polarized light in the image information to generate image information with polarized light eliminated, so as to generate the target image with the polarized light reduced. The problem of blurring image caused by the specular reflection is solved in the target image.

In a second exemplary method, the image processor 12 may be configured to calculate the intensity of the polarized light in each image information, filter all the image information out of the polarized light, and fuse and superimpose the filtered image information to generate a target image with reduced polarized light.

In this exemplary method, after obtaining A, B, and α, the image processor 12 may further configured to calculate the intensity and polarization angle of the unfiltered polarized light in the image information corresponding to each lens module 111. Further, the image processor 12 can eliminate the unfiltered polarized light in all the image information to generate image information with polarized light eliminated. The image processor 12 may further be configured to fuse and superimpose image information with polarized light eliminated, so as to generate a target image with reduced polarized light. The problem of blurring image caused by the specular reflection can be solved in the target image. Compared to the first exemplary method, the second exemplary method can generate the target image with higher brightness.

During the imaging process, a slightly hand shaking of a user may affect the imaging quality and cause the image blurring. To solve this problem, according to embodiments of the present disclosure, during a photographing process using the imaging system, the image processor 12 may further be configured to process the target image based on techniques, such as artificial intelligence, machine learning, and deep learning, to improve the quality of the target image.

FIG. 6 is a diagram of an experiment comparing imaging effects according to an embodiment of the present disclosure. An imaging effect of a conventional imaging system is shown in the left of FIG. 6. Because specular reflection is formed by the window glass region, in the image, a region of the window glass is blurring and not clear. An imaging effect of the imaging system according to embodiments of the present disclosure is as shown in the right of FIG. 6. It is obvious that the imaging system according to the embodiment of the present disclosure can eliminate the problem of imaging blurring of the corresponding area caused by the specular reflection of the window glass, improving the image quality.

According to the above description, the imaging system provided by embodiments of the present disclosure may collect image information using a lens device having a plurality of lens modules. The polarization angles of the polarizers in different lens module are different. Thus, image information of the sub-images can be used to calculate the information of the polarized light. The target image with reduced polarized light can be generated according to the image information and the information of the polarized light. Such that, it is possible to avoid blurring image caused by the specular reflection, improving imaging quality of the electronic device.

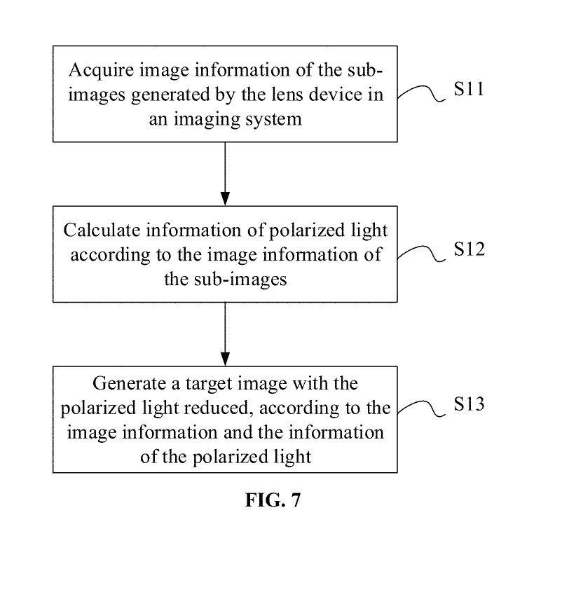

Based on the above imaging system, another aspect of the present disclosure further provides an imaging method, e.g. an exemplary imaging method shown in FIG. 7, which can be implemented by the imaging system to perform imaging. FIG. 7 is a flowchart of an imaging method according to an embodiment of the present disclosure. The imaging method may include the following procedures.

In S11: Image information of the sub-images generated by the lens device is acquired by the imaging system.

In S12: Information of the polarized light is calculated by the imaging system according to the image information of the sub-images.

In S13: According to the image information and the information of the polarized light, a target image with the polarized light reduced is generated by the imaging system.

In some embodiments, the ambient incident light input to imaging system may include unpolarized light and polarized light. Based on image information of the sub-images, the information of the polarized light can be calculated. Specially, according to a relationship between the image information and an intensity of the unpolarized light and an intensity of the polarized light, the information of the polarized light can be calculated.

In some embodiments, the information of the polarized light may include the intensity of the incident polarized light input to the polarizer and the polarization angle of the polarized light. The target image with the polarized light reduced can be generated based on the image information and the information of the polarized light. Specially, the intensity of the polarized light in the image information may be calculated based on the intensity of the incident polarized light to the polarizer, the polarization angle of the polarized light, and a current polarization angle of the polarizer. Based on the calculation result, the target image can be generated.

In some embodiments, the generating the target image with reduced polarized light according to the image information and the information of the polarized light information includes: calculating the intensity of the polarized light in the image information and generating the target image with reduced polarized light based on the image information and the intensity of the polarized light in the image information. In some embodiments, the generating the target image with reduced polarized light according to the image information and the information of the polarized light information includes: calculating the intensity of the polarized light in each image information, filtering all the image information out of the polarized light, and fusing and superimposing the filtered image information to generate a target image with reduced polarized light.

The imaging method can be implemented by the image processor in the imaging system according to embodiments of the present disclosure. In the imaging method provided by embodiments of the present disclosure, a plurality of image information using a lens device having a plurality of lens modules may be collected. According to image information of the sub-images, the information of the polarized light can be calculated. The target image with reduced polarized light can be generated according to the image information and the information of the polarized light. Such that, it is possible to avoid blurring image caused by the specular reflection, improving imaging quality of the electronic device.

In some other embodiments of the present disclosure, the lens device may include a lens module, which includes a polarizer, a lens, and a photosensitive sensor. For detail descriptions of the structure and working principles, references can be made to the lens device with a plurality of lens modules.

Embodiments of the present specification are described in a progressive manner, and each embodiment focuses on differences from other embodiments, and the same or similar parts between the various embodiments may be referred to each other. The device disclosed in the present disclosure corresponds to the method disclosed in the present disclosure, thus, the description of the device is relatively simple, and the relevant part can be referred to the description of the method.

The above description of the disclosed embodiments enables those skilled in the art to implement or use the disclosure. Various modifications to these disclosed embodiments are obvious to those skilled in the art, and the general principles defined herein may be implemented in other embodiments without departing from the spirit or scope of the disclosure. Therefore, the present disclosure is not limited to the embodiments disclosed herein, but the scope of the disclosure is to be accorded as the widest range consistent with the principles and novel features disclosed herein.

What is claimed is:

1. An imaging system, including:
an image processor; and
a lens module coupled to the image processor, the lens module comprising:
a polarizer having a polarization angle and filtering light according to the polarization angle;
a lens arranged adjacent to the polarizer to receive the filtered light through the polarizer; and
a photosensitive sensor arranged adjacent to the lens, and configured to sense light to generate image information of an image,
wherein the image processor is configured to obtain information of polarized light according to the image information of the image and to generate a target image with reduced polarized light.

2. The imaging system according to claim 1, wherein:
ambient incident light that incidents on the polarizer of the lens module comprises unpolarized light and the polarized light; and
the image processor is configured to calculate the information of the polarized light, according to a relationship between the image information of the image, and an intensity of the unpolarized light and an intensity of the polarized light.

3. The imaging system according to claim 1, wherein:
the image sensor further includes a memory configured to store the polarization angle of the polarizer;
the information of the polarized light includes an intensity of the incident polarized light input to the polarizer of the lens module and a polarization angle of the polarized light; and
the image processor is configured to calculate the intensity of the polarized light in the image information based on the intensity of the incident polarized light to the polarizer, the polarization angle of the polarized light, and a polarization angle of the polarizer, and to generate the target image with reduced polarized light based on the calculation result.

4. The imaging system according to claim 3, wherein:
the image processor is configured to calculate the intensity of the polarized light in the image information and to generate the target image with reduced polarized light based on the image information and the intensity of the polarized light in the image information.

5. The imaging device of claim 1, wherein the polarization angle of the polarizer is between 0 degree and 90 degree.

6. An imaging method, to be implemented by the imaging system including an image processor, and a lens module coupled to the image processor, the lens module including a polarizer, a lens, and a photosensitive sensor, the method comprising:
filtering light by the polarizer with a polarization angle;
sensing the light filtered through the polarizer;
acquiring image information of an image obtained by the imaging system;
calculating information of polarized light according to the image information of the image; and
generating a target image with the polarized light reduced according to the image information of the image and the information of the polarized light.

7. The imaging method according to claim 6, wherein:
the ambient incident light on the polarizer in the imaging system comprises unpolarized light and polarized light; and
calculating the information of the polarized light according to the image information includes:
calculating the information of the polarized light according to a relationship between image information and an intensity of the unpolarized light and an intensity of the polarized light.

8. The imaging method according to claim 6, wherein:
the polarized light information includes the intensity of the polarized light input to the polarizer and the polarization angle of the polarized light;
generating the target image with the polarized light reduced, according to the image information and the information of the polarized light includes:
calculating the intensity of the polarized light in the image information to obtain a calculation result based on the intensity of the incident polarized light to the polarizer, the polarization angle of the polarized light, and the current polarization angle of the polarizer; and
generating the target image based on the calculation result.

9. The imaging method according to claim 8, wherein generating the target image with the polarized light reduced, according to the image information and the information of the polarized light includes:
calculating the intensity of the polarized light in the image information; and
generating the target image with reduced polarized light based on the image information and the intensity of the polarized light in the image information.

10. An imaging system, including:
an image processor; and
a lens device coupled to the image process, the lens device including a plurality of lens modules, each lens module comprising:
a polarizer having a polarization angle and polarizing light according to the polarization angle;
a lens arranged adjacent to the polarizer to receive the filtered light from the polarizer; and
a photosensitive sensor arranged adjacent to the lens, and configured to sense light to generate image information of a sub-image,
wherein polarization angles of the polarizers in different lens modules are different from each other; and the image processor is configured to obtain information of polarized light according to the image information of sub-images and to generate a target image with reduced polarized light.

11. The imaging system according to claim 10, wherein:
ambient incident light that incidents on the polarizer of the lens modules comprises unpolarized light and the polarized light; and
the image processor is configured to calculate the information of the polarized light according to a relationship between the image information, and an intensity of the unpolarized light, and an intensity of the polarized light.

12. The imaging system according to claim 10, wherein:
the image sensor further stores a polarization angle of each polarizer;
the information of the polarized light includes an intensity of the incident polarized light input to the polarizers of the lens modules and a polarization angle of the polarized light; and
the image processor is configured to calculate the intensity of the polarized light in the image information based on the intensity of the incident polarized light to the polarizer, the polarization angle of the polarized light, and a polarization angle of the polarizer, and generate the target image based on the calculation result.

13. The imaging system according to claim 12, wherein:
the image processor is configured to calculate the intensity of the polarized light in the image information, and generate the target image with reduced polarized light based on the image information and the intensity of the polarized light in the image information.

14. The imaging system according to claim 12, wherein:
the image processor is configured to calculate the intensity of the polarized light in the image information of each sub-image, filter all the image information out of the polarized light to obtain filtered image information, and fuse and superimpose the filtered image information to generate a target image with reduced polarized light.

15. The imaging device of claim 10, wherein the polarization angle of the polarizer of each of the lens modules is between 0 degree and 90 degree.

16. An imaging method, to be implemented by the imaging system including an image processor, and a lens device coupled to the image processor, the lens device including a plurality of lens modules, each lens module including a polarizer, a lens, and a photosensitive sensor, the method comprising:
filtering light by each polarizer with the polarization angle;
sensing light filtered through the polarizer;
acquiring image information of each sub-image generated by the lens device in the imaging system;
calculating information of polarized light according to the image information of sub-images; and
generating a target image with the polarized light reduced, according to the image information of the sub-images and the information of the polarized light.

17. The imaging method according to claim 16, wherein:
the ambient incident light on the polarizer in the imaging system comprises unpolarized light and polarized light; and
calculating the information of the polarized light according to the image information includes:
calculating the information of the polarized light according to a relationship between the image information and the intensity of the unpolarized light and the intensity of the polarized light.

18. The imaging method according to claim 16, wherein:
the polarized light information includes the intensity of the incident polarized light input to the polarizer and the polarization angle of the polarized light;
generating the target image with the polarized light reduced, according to the image information and the information of the polarized light includes:
calculating the intensity of the polarized light in the image information to obtain a calculation result, based on the intensity of the incident polarized light to the polarizer, the polarization angle of the polarized light, and the current polarization angle of the polarizer; and
generating the target image based on the calculation result.

19. The imaging method according to claim 18, wherein generating the target image with the polarized light reduced, according to the image information and the information of the polarized light includes:
calculating the intensity of the polarized light in the image information; and
generating the target image with reduced polarized light based on the image information and the intensity of the polarized light in the image information.

20. The imaging method according to claim 18, wherein generating the target image with the polarized light reduced, according to the image information and the information of the polarized light includes:
calculating the intensity of the polarized light in each image information;
filtering all the image information out of the polarized light to obtain the filtered image information; and
fusing and superimposing the filtered image information to generate a target image with reduced polarized light.
